(19) United States
(12) Patent Application Publication
(10) Pub. No.: US 2010/0182302 A1
(43) Pub. Date: Jul. 22, 2010

(54) Display panel driver, display device, and method of operating the same

(75) Inventors: Toshiaki Ueda, Shiga (JP); Akira Fujiwara, Kanagawa (JP); Tamotsu Okutani, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/656,028

(22) Filed: Jan. 13, 2010

(30) Foreign Application Priority Data
Jan. 19, 2009 (JP) 2009-008534

(51) Int. Cl. G06F 3/038

(52) U.S. Cl. 345/211; 345/55

(57) ABSTRACT

A display panel driver is provided with an output terminal to be connected to a data line of a display panel; a recovery capacitor connection terminal to be connected to a recovery capacitor; and a recovery switch connected between the output terminal and the recovery capacitor connection terminal. The recovery switch includes first and second MOS transistors of the same conductivity type. The drain of the first MOS transistor is connected to the recovery capacitor connection terminal, and the drain of the second MOS transistor is connected to the output terminal. The sources of the first and second MOS transistors are connected to each other.

### INCORPORATION BY REFERENCE

This application claims the benefit of priority based on Japanese Patent Application No. 2009-008534, filed on Jan. 19, 2009, the disclosure of which is incorporated herein by reference.

### BACKGROUND OF THE INVENTION

1. Field of the Invention

The present invention relates to a display panel driver, and more specifically to a charge recovery technique in display panel driving.

2. Description of the Related Art

The charge recovery is one of the techniques used for reducing power consumption of a panel display device provided with a display panel, such as a PDP (plasma display panel), an LCD (liquid crystal display) panel, an OLED (organic light-emitting diode) panel, or an inorganic light-emitting diode panel, which operates as a capacitive load. The charge recovery is a technique for efficiently using energy by recovering charges from a display panel to a recovery capacitor after the data lines are driven and supplying charges from the recovery capacitor to the display panel before the data lines are driven. Such a technique is disclosed in, for example, Japanese Laid Open Patent Application No. P2005-210119A.

FIG. 1A is a circuit diagram showing a typical configuration of an output circuitry 100 of a display panel driver adapted to charge recovery. Illustrated in FIG. 1A are only portions for driving one data line of the output circuitry 100. In FIG. 1A, the symbol VDD2 denotes the voltage level of the power supply terminal (power supply level), and the symbol VSS2 denotes the voltage level of the ground terminal (ground level).

The output circuitry 100 includes: a pull-up transistor Gp connected between an output terminal OUT and the power supply terminal; and a pull-down transistor Gn connected between the output terminal OUT and the ground terminal. Here, the pull-up transistor Gp is a PMOS transistor, and the pull-down transistor Gn is an NMOS transistor. The output terminal OUT is further connected to a recovery capacitor connection terminal ERC via a recovery switch SW. An external recovery capacitor C_{ER} is connected to the recovery capacitor connection terminal ERC.

FIG. 1B is a circuit diagram showing the configuration of the recovery switch SW. The recovery switch SW includes: an NMOS transistor 101, a PMOS transistor 102, which are connected in parallel, and an inverter 103. The sources (or drains) of the NMOS transistor 101 and the PMOS transistor 102 are connected to the recovery capacitor connection terminal ERC and the drains (or sources) thereof are connected to the output terminal OUT. A control signal Gs is fed to the gate of the NMOS transistor 101, and an inversion signal of the control signal Gs generated by the inverter 103 is fed to the gate of the PMOS transistor 102. The back gate of the NMOS transistor 101 is fixed at the ground level, and the back gate of the PMOS transistor 102 is fixed at the power supply level.

The NMOS transistor 101 and the PMOS transistor 102 are typically configured so that the sources and drains thereof have a high breakdown voltage. This is because a voltage of the voltage level VDD2 may be applied to both of the sources (drains) of the NMOS transistor 101 and the PMOS transistor 102 connected to the output terminal OUT and the drains (sources) thereof connected to the recovery capacitor connection terminal ERC. The need of using MOS transistors with high-withstand voltage sources and drains would be understood to those skilled in the art.

FIG. 2 is a timing chart showing an exemplary operation of the output circuitry 100 shown in FIGS. 1A and 1B. In an initial state, the output terminal OUT is set to the low level and the recovery switch SW is placed into the OFF state (that is, the control signal Gs is set to the low level). When the output terminal OUT is pulled up to the high level from the low level, a recovery control signal CE is first asserted, and the control signal Gs is further pulled up to the high level. Consequently, the recovery switch SW is turned on and charges are supplied from the recovery capacitor C_{ER} to the corresponding data line of the display panel via the recovery switch SW. Then the control signal Gs is pulled down to the low level to turn off the recovery switch SW, and also the pull-up transistor Gp is turned ON, whereby the data line is pulled up to the high level.

Similarly, when the output terminal OUT is pulled down to the low level from the high level, the recovery control signal CE is first asserted and the control signal Gs is pulled up to the high level. Consequently, the recovery switch SW is turned on and charges are supplied from the recovery capacitor C_{ER} to the data line of the display panel via the recovery switch SW. Then the recovery switch SW is turned off, and also the pull-down transistor Gn is turned on, whereby the data line is pulled down to the low level.

It should be noted that the operation of switching the recovery switch SW from the OFF state to the ON state and further switching to the OFF state is performed in the operation of FIG. 2, in both of the cases of pulling up the output terminal OUT from the low level to the high level and pulling down the output terminal OUT from the high level to the low level.

One problem of the configuration shown in FIG. 1B is that the area required for integrating the recovery switch SW is large. As described above, transistors with a high withstand voltage at both of the sources and drains need to be used as the NMOS transistor 101 and the PMOS transistor 102 including the recovery switch SW. However, the sizes of such transistors are undesirably large. In addition, in the voltage range around the intermediate potential VDD2/2 at which the recovery switch SW operates, the ON resistances of the NMOS transistor 101 and PMOS transistor 102 increase due to the back gate effect. That is, the ON resistances of the NMOS transistor 101 and the PMOS transistor 102 undesirably increase due to the voltage level differences between the source and the back gate level of the NMOS transistor 101 and the PMOS transistor 102. The areas of the NMOS transistor 101 and the PMOS transistor 102 need to be increased to address the increased ON resistances due to the back gate effect.

Another problem is that the recovery switch SW needs to be operated with a high frequency and this undesirably increases power consumption required for operating the recovery switch SW. As described above, the configuration of the recovery switch SW of FIG. 1B necessitates switching the recovery switch SW from the OFF state to the ON state and then further to the OFF state, every when the output terminal OUT is switched from the low level to the high level or from the high level to the low level. That is, the recovery switch SW needs to be operated with the frequency twice as high as the operating frequency of the output circuitry 100. This undesirably increases power consumption in the recovery switch SW.

Still another problem is difficulty in controlling operation timings of the pull-up transistor Gp, the pull-down transistor Gn and the recovery switch SW. Inappropriate control of the timings at which the recovery switch SW is turned into the ON state and at which the pull-up transistor Gp and the pull-down transistor Gn are turned into the ON state results in an undesired current flow to the recovery capacitor C_{ER}, which does not distribute the charge recovery and the supply of the recovered charges. This undesirably deteriorates the charge recovery efficiency and the use efficiency of recovered charges. For example, turning of both the pull-up transistor Gp and the recovery switch SW into the ON state may result in a current flow from the power supply terminal to the recovery capacitor C_{ER}, increasing the voltage across the recovery capacitor C_{ER}. This reduces the charge recovery efficiency. On the other hand, turning of both the pull-down transistor Gn and the recovery switch SW into the ON state may result in current flow from the recovery capacitor C_{ER} to the ground terminal, discarding the charges accumulated across the recovery capacitor C_{ER} to the ground terminal. To avoid the deterioration in the charge recovery efficiency and the charge use efficiency, delicate timing control of the pull-up transistor Gp, the pull-down transistor Gn, and the recovery switch SW is required.

### SUMMARY

In an aspect of the present invention, a display panel driver is provided with an output terminal to be connected to a data line of a display panel; a recovery capacitor connection terminal to be connected to a recovery capacitor; and a recovery switch connected between the output terminal and the recovery capacitor connection terminal. The recovery switch includes first and second MOS transistors of the same conductivity type. The drain of the first MOS transistor is connected to the recovery capacitor connection terminal, and the drain of the second MOS transistor is connected to the output terminal. The sources of the first and second MOS transistors are connected to each other.

In another aspect of the present invention, a display panel driver is provided with an output terminal to be connected to a data line of a display panel; a recovery capacitor connection terminal to be connected to a recovery capacitor; and a recovery switch connected between said output terminal and said recovery capacitor connection terminal. The recovery switch is configured to be settable into first and second states in response to a control signal, wherein the first state is a state to allow a current to flow only in a direction from said output terminal to said recovery capacitor connection terminal, and the second state is a state to allow a current to flow only in a direction from said recovery capacitor connection terminal to said output terminal.

In still another aspect of the present invention, a method is provided for operating a display panel driver including an output terminal connected to the data line, a recovery capacitor connection terminal to be connected to a recovery capacitor, and a recovery switch connected between the output terminal and the recovery capacitor connection terminal. The method includes:
placing the recovery switch into a first state to allow a current to flow only in a direction from the output terminal to the recovery capacitor connection terminal; and
placing the recovery switch into a second state to allow a current to flow only in a direction from the recovery capacitor connection terminal to the output terminal.

In one embodiment of the present invention, the area required for integrating a recovery switch is effectively reduced. In another embodiment of the present invention, the operating frequency of a control signal for operating the recovery switch is reduced and also the timing control of the control signal is facilitated.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1A is a circuit diagram showing a typical configuration of an output circuitry of a display panel driver adapted to charge recovery;

FIG. 1B is a circuit diagram showing the configuration of a recovery switch of the output circuitry shown in FIG. 1A;

FIG. 2 is a timing chart showing an exemplary operation of the output circuitry shown in FIG. 1A;

FIG. 3 is a block diagram showing an exemplary configuration of a display panel driver in a first embodiment of the present invention;

FIG. 4 is a circuit diagram showing an exemplary configuration of an output circuit of the display panel driver of FIG. 3;

FIG. 5 is a circuit diagram showing an exemplary configuration of a recovery switch in a first embodiment;

FIG. 6 is a timing chart showing an exemplary operation of the output circuit of FIG. 4;

FIG. 7 is a circuit diagram showing another exemplary configuration of the output circuit;

FIG. 8 is a timing chart showing an exemplary operation of the output circuit of FIG. 7;

FIG. 9A is a graph showing simulation results of the operation of the output circuit of FIG. 7 in a case where the initial voltage of the recovery capacitor is VDD2/2;

FIG. 9B is a graph showing a simulation result of the operation of the output circuit of FIG. 7 in a case where the initial voltage of the recovery capacitor is 0;

FIG. 10 is a timing chart showing an exemplary operation of pre-charging the recovery capacitor in the output circuit of FIG. 7;

FIG. 11 is a graph showing a simulation result of the pre-charging operation of the recovery capacitor;

FIG. 12 is a circuit diagram showing an exemplary configuration of a recovery switch in a second embodiment;

FIG. 13A is a circuit diagram showing an exemplary configuration of a recovery switch according in a third embodiment; and

FIG. 13B is a circuit diagram showing another exemplary configuration of the recovery switch according to the third embodiment.

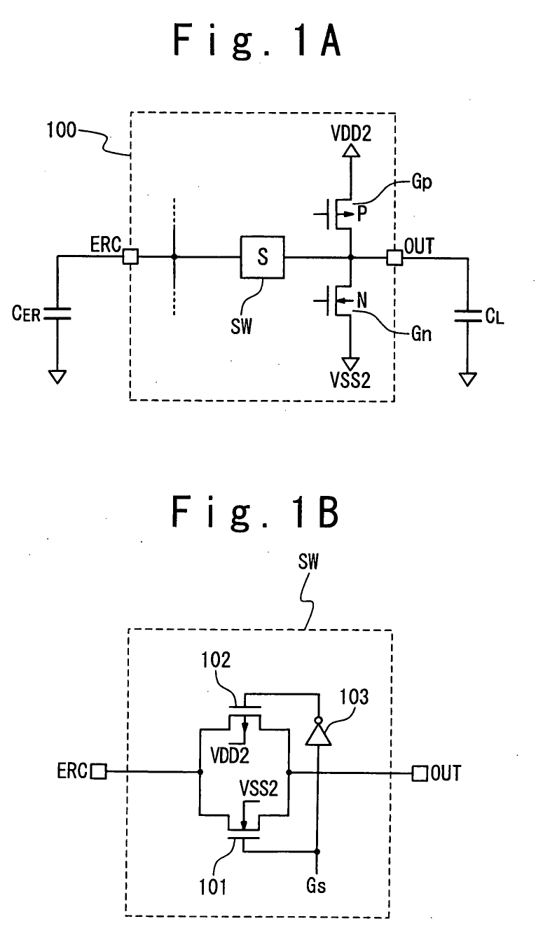

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

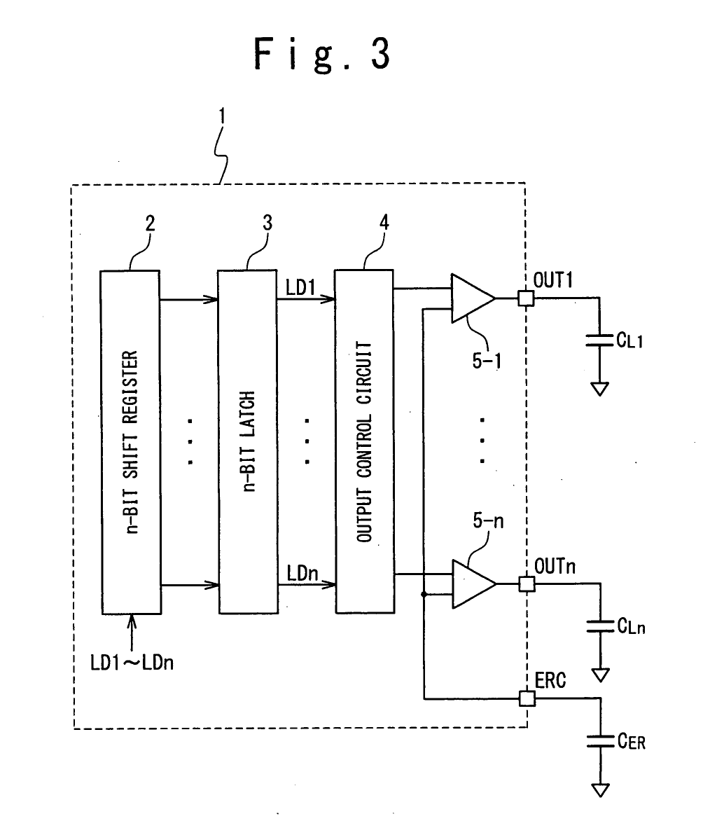

FIG. 3 is a block diagram showing an exemplary configuration of a display panel driver 1 in a first embodiment of the present invention. The display panel driver 1 is provided with output terminals OUT1 to OUTn respectively connected to n data lines of a display panel, and is so configured as to drive these n data lines. The display panel driver 1 and the display panel compose a panel display device. In this embodiment, the display panel driven by the display panel driver 1 is a PDP (plasma display panel). It should be noted, however, that a display panel that operates as a capacitive load may be used instead of the PDP. An LCD (liquid crystal display) panel, and a voltage-driven OLED panel and a voltage-driven inorganic LED panel are typical examples of a display panel that operates as a capacitive load. In FIG. 3, the n data lines of the display panel are illustrated as load capacities CL1 to CLn. Hereinafter, the configuration of the display panel driver 1 will be described in detail.

The display panel driver 1 includes: an n-bit shift register 2; an n-bit latch 3; an output control circuit 4; and output circuits 5-1 to 5-n. The n-bit shift register 2 sequentially latches serially inputted display data signals LD1 to LDn and outputs the display data signals LD1 to LDn in parallel. The display data signals LD1 to LDn respectively indicate the voltage levels to which the respective data lines connected to the output terminals OUT1 to OUTn should be driven. The n-bit latch 3 latches the display data signals LD1 to LDn from the n-bit shift register 2, and transfers the latched display data signals LD1 to LDn to the output control circuit 4. The output control circuit 4 is responsive to the display data signals LD1 to LDn for supplying control signals to the output circuits 5-1 to 5-n, thereby controlling the output circuits 5-1 to 5-n.

The output circuits 5-1 to 5-n are responsive to the control signals received from the output control circuit 4 for respectively driving the output terminals OUT1 to OUTn to the high level (that is, the power supply voltage VDD2) or the low level (that is, the ground voltage VSS2). More specifically, the output circuit 5-i drives the output terminal OUTi to the high level when the display data signal LDi is set to the high level, and the output circuit 5-i drives the output terminal OUTi to the low level when the display data signal LDi is set to the low level. Further, the output circuits 5-1 to 5-n are commonly connected to a recovery capacitor connection terminal ERC. Here, the recovery capacitor connection terminal ERC is an external connection terminal to which an external recovery capacitor C_{ER} is connected. In this embodiment, the recovery capacitor C_{ER} is externally connected to the display panel driver 1.

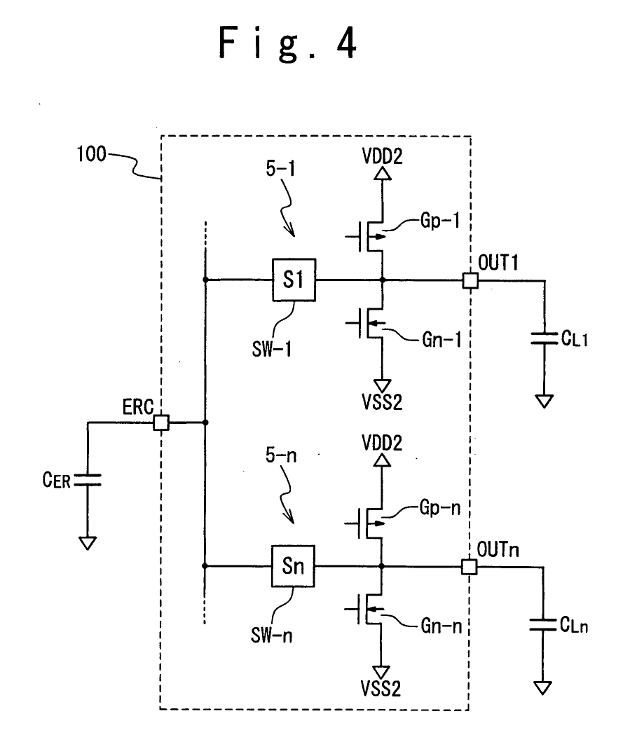

FIG. 4 is a circuit diagram showing an exemplary configuration of the output circuits 5-1 to 5-n. For simplicity, only two output circuits 5 are illustrated in FIG. 4. Each output circuit 5-i includes: a pull-up transistor Gp-i; a pull-down transistor Gn-i, and a recovery switch SW-i. The pull-up transistor Gp-i is a PMOS transistor used for pulling up the output terminal OUTi to the supply voltage VDD2, and the pull-down transistor Gn-i is an NMOS transistor used for pulling down the output terminal OUTi to the ground voltage VSS2. The recovery switch SW-i is connected between the output terminal OUTi and the recovery capacitor connection terminal ERC, and is used to provide electrical connection between the data line connected to the output terminal OUTi and the recovery capacitor C_{ER}.

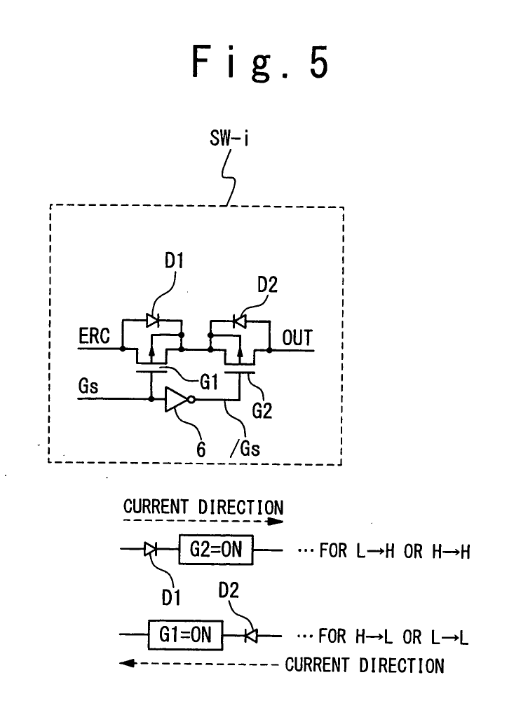

FIG. 5 is a circuit diagram showing an exemplary configuration of each recovery switch SW-i. Each recovery switch SW-i includes: a pair of gate transistors G1 and G2 having commonly-connected sources, and an inverter 6. In this embodiment, the gate transistors G1 and G2 are both PMOS transistors. The drain of the gate transistor G1 is connected to the recovery capacitor connection terminal ERC, and the drain of the gate transistor G2 is connected to the output terminal OUTi. A control signal Gs is supplied to the gate of the gate transistor G1, and an inversion signal /Gs of the control signal Gs generated by the inverter 6 is supplied to the gate of the gate transistor G2.

Within the gate transistors G1 and G2, parasitic diodes D1 and D2 are formed respectively. The parasitic diode D1 is formed to allow a current flow in the direction from the drain to the source across the gate transistor G1, and similarly, the parasitic diode D2 is formed to allow a current flow in the direction from the drain to the source across the gate transistor G2. As described later, the parasitic diodes D1 and D2 are used to determine the direction of the current flow through the recovery switch SW-i.

Used as the gate transistors G1 and G2 are MOS transistors in which only the drains are formed with a high withstand voltage; the drains of the gate transistors G1 and G2 have a higher withstand voltage than the sources thereof. In the recovery switch SW-i with the configuration of FIG. 4, the sources of the gate transistors G1 and G2 are configured to be floating, and thus the sources of the gate transistors G1 and G2 do not have to be formed with a high withstand voltage. Therefore, the use of the MOS transistors in which only the drains are formed with a high withstand voltage as the gate transistors G1 and G2 does not raise a problem with the withstand voltage of the sources. Rather, the use of the MOS transistors in which only the drains are formed with a high withstand voltage effectively reduces the element area and also reduces the area of the recovery switch SW-i (compared to the MOS transistors in which both of the source and drain have a high withstand voltage).

It is preferable that the gate transistors G1 and G2 of the recovery switch SW-i be arranged in a region electrically separated from other elements of the display panel driver 1 by an element isolation film (for example, a LOCOS (local oxidation of silicon) insulation film or trench insulation film). Such arrangement is effective in avoiding inflow of a parasitic current into the recovery capacitor C_{ER} and outflow of the parasitic current from the recovery capacitor C_{ER}.

The back gate of the gate transistor G1 is directly connected to the source thereof, and the back gate of the gate transistor G2 is directly connected to the source thereof. Such connection makes the voltage level of the back gate equal to that of the source in the gate transistors G1 and G2, and effectively avoids an increase in the ON resistances of the gate transistors G1 and G2 due to the back gate effect. This is effective in improving the charge recovery efficiency.

In feeding charges from the recovery capacitor C_{ER} to the data line connected to the output terminal OUTi and in recovering charges from the data line to the recovery capacitor C_{ER}, only one of the gate transistors G1 and G2 of the recovery switch SW-i is turned ON. Consequently, the recovery switch SW-i operates to allow only a unidirectional current flow (not bidirectional current flow). More specifically, when the charges are fed from the recovery capacitor C_{ER} to the data line connected to the output terminal OUTi, the control signal Gs is pulled up to the high level, whereby the gate transistor G1 is set to the OFF state and the gate transistor G2 is set to the ON state. Under such conditions, the recovery switch SW-i allows flowing a current in the direction from the recovery capacitor connection terminal ERC to the output terminal OUTi via the parasitic diode D1 of the gate transistor G1 and the channel of the gate transistor G2. The direction of the current flowing through the recovery switch SW-i is determined by the direction of the parasitic diode D1 of the gate transistor G1. When charges are recovered from the data line to the recovery capacitor C_{ER}, on the other hand, the control signal Gs is pulled down to the low level, whereby the gate transistor G1 is set to the ON state and the gate transistor G2 is set to the OFF state. Under such conditions, the recovery switch SW-i allows flowing a current in the direction from the output terminal OUTi to the recovery capacitor connection terminal ERC via the parasitic diode D2 of the gate transistor G2 and the channel of the gate transistor G1. The direction of the current flowing through the recovery switch SW-i is determined by the direction of the parasitic diode D2 of the gate transistor G2.

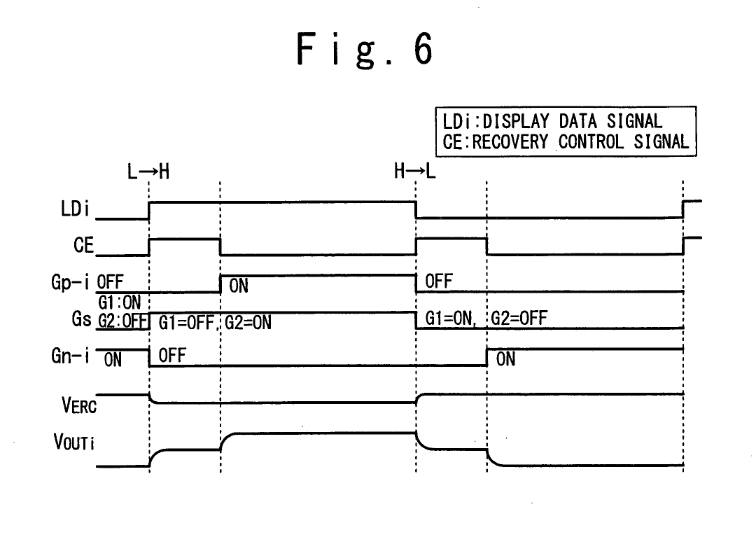

FIG. 6 is a timing chart showing an exemplary operation of the output circuit 5-i, particularly, the operation of the recovery switch SW-i. Initially, the control signal Gs is set to the low level and the output terminal OUTi is set to the low level. That is, in the initial state, the gate transistor G1 is turned ON and the gate transistor G2 is turned OFF.

In pulling up the output terminal OUTi from the low level to the high level, a recovery control signal CE is first asserted and also the control signal Gs is pulled up to the high level. The recovery control signal CE here is a signal generated within the output control circuit 4 to control the charge recovery from the data line and the charge supply to the data line. In response to the assertion of the recovery control signal CE, both the pull-up transistor GP-i and the pull-down transistor Gn-i are turned OFF. In response to the pull up of the control signal Gs to the high level, on the other hand, the gate transistor G1 is turned off and the gate transistor G2 is turned on. Consequently, the recovery switch SW-i is operated to allow a current to flow in the direction from the recovery capacitor connection terminal ERC to the output terminal OUTi, and the charges are supplied from the recovery capacitor C_{ER} to the output terminal OUTi (that is, the data line of the display panel) via the recovery switch SW-i. This results in that the voltage V_{OUTi} of the output terminal OUTi, that is, the voltage of the data line, is increased up to an intermediate voltage level. Then the recovery control signal CE is negated, and the pull-up transistor Gp-i is turned on to pull up the output terminal OUTi to the High level.

In pulling down the output terminal OUTi from the high level to the low level, on the other hand, the recovery control signal CE is asserted and also the control signal Gs is pulled down to the low level. In response to the assertion of the recovery control signal CE, both the pull-up transistor GP-i and the pull-down transistor Gn-i are turned off. In response to the pull-down of the control signal Gs to the low level, on the other hand, the gate transistor G1 is turned on and the gate transistor G2 is turned off. Consequently, the recovery switch SW-i is operated to allow a current to flow in the direction from the output terminal OUTi to the recovery capacitor connection terminal ERC, and the charges are recovered from the data line (that is, from the output terminal OUTi) to the recovery capacitor C_{ER} via the recovery switch SW-i. This results in that the voltage V_{OUTi} of the output terminal OUTi, that is, the voltage of the data line is decreased. Then the recovery control signal CE is negated, and also the pull-down transistor Gn-i is turned on to pull down the output terminal OUTi to the low level.

Switching of the state of the recovery switch SW-i (that is, switching between the state in which the gate transistor G1 is turned on and the gate transistor G2 is turned off and the state in which the gate transistor G1 is turned off and the gate transistor G2 is turned on) is performed only when the voltage of the output terminal OUTi is to be switched. This effectively reduces the number of times of switching of the voltage level of the control signal Gs fed to the gate transistors G1 and G2, achieving power consumption reduction.

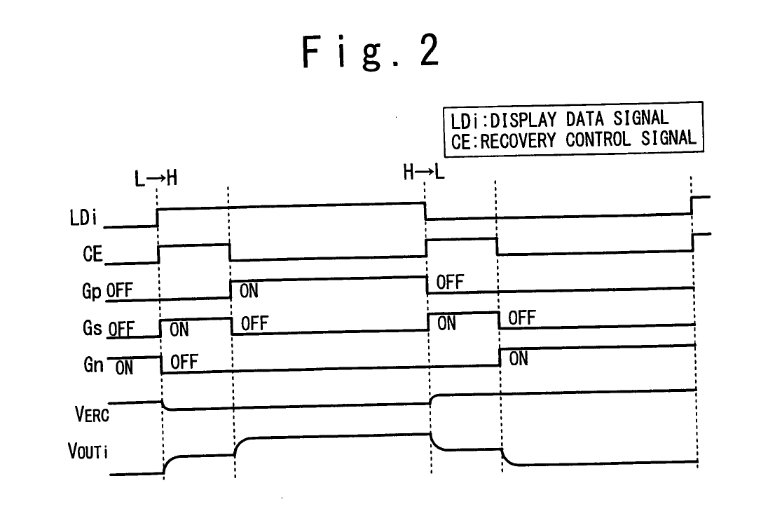

It should be noted that the operation of FIG. 6 does not require switching the control signal Gs for stopping the charge recovery from the data line or the charge supply to the data line. This is because the recovery switch SW-i is configured to flow the current only unidirectionally. Since the recovery switch SW-i is configured to flow a current only unidirectionally, charge backflow from the data line to the recovery capacitor C_{ER} does not occur even when the control signal Gs is not switched after the charge supply from the recovery capacitor C_{ER} to the data line is completed. Similarly, charge backflow from the recovery capacitor C_{ER} to the data line does not occur even when the control signal Gs is not switched after the charge recovery from the data line to the recovery capacitor C_{ER} is completed. Therefore, the switching of the control signal Gs needs to be performed only once In the operation of FIG. 6, in either of the case where the output terminal OUTi is switched from the low level to the high level or the case where the output terminal OUTi is switched from the high level to the low level. Such operation effectively reduces the frequency of the control signal Gs, thereby achieving power consumption reduction (compared to the operation of FIG. 2). The reduction in the frequency of the control signal Gs is also preferable in terms of easiness of the timing control of the control signal Gs, that is, in a point that the control of the operation timings of the pull-up transistor Gp, the pull-down transistor Gn and the recovery switch SW is facilitated.

With the configuration of FIG. 5, the recovery capacitor connection terminal ERC can also be used as an external control terminal for prohibit the display panel driver 1 from performing charge recovery operation. That is, the configuration of FIG. 5 makes it easy to prohibit the display panel driver 1 from performing charge recovery operation. More specifically, the display panel driver 1 does not perform a charge recovery operation, when the recovery capacitor connection terminal ERC is set to the supply voltage VDD2 and further the control signal Gs is set at the low level (that is, the gate transistor G1 is turned on and the gate transistor G2 is turned off). This makes it easy to satisfy a need of a user who does not desire the charge recovery operation.

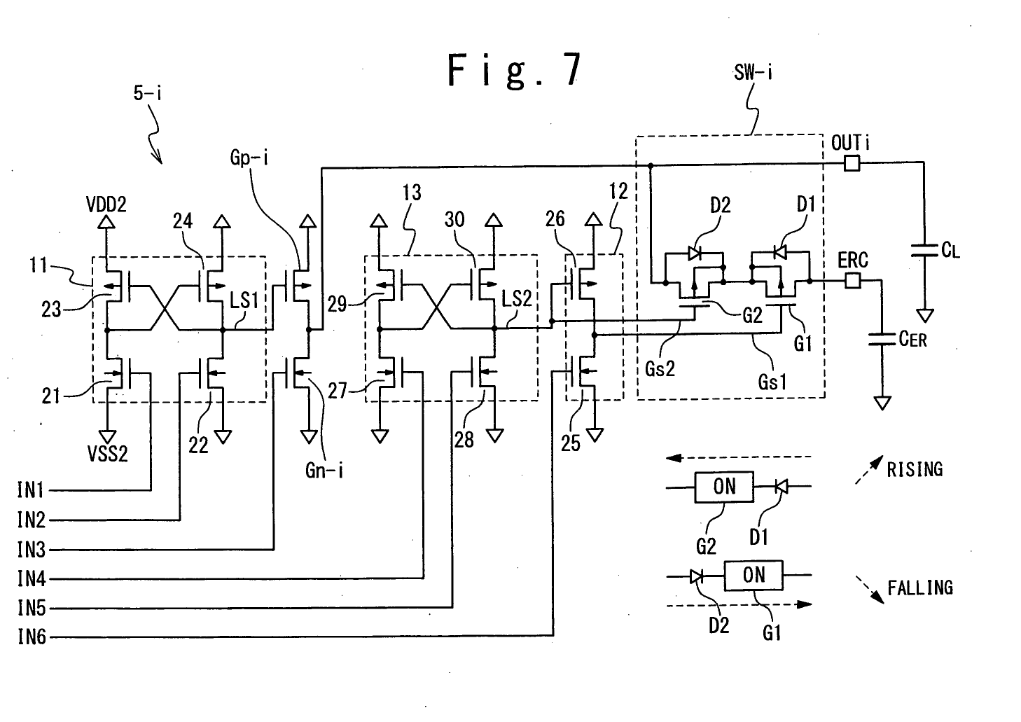

FIG. 7 is a circuit diagram showing a more practical configuration of the output circuit 5-i. The circuit configuration of FIG. 7 is directed to provide more precise control of the timings at which the pull-up transistor Gp-i or the pull-down transistor Gn-i is turned on and the timing at which the gate transistors G1 and G2 are switched.

In the circuit of FIG. 7, the output of a level shifter 11 is connected to the gate of the pull-up transistor Gp-i. The level shifter 11 includes: NMOS transistors 21 and 22; and PMOS transistors 23 and 24. In addition, a buffer 12 is connected to the gate of the gate transistor G1 of the recovery switch SW-i, and the output of a level shifter 13 is connected to the gate of the gate transistor G1. The buffer 12 includes an NMOS transistor 25 and a PMOS transistor 26. The level shifter 13 includes NMOS transistors 27 and 28, and PMOS transistors 29 and 30. The level shifter 13 is also connected to the gate of the PMOS transistor 26 of the buffer 12. The output signal of the level shifter 11 is used as a control signal supplied to the gate of the pull-up transistor Gp-i. Moreover, the output signal of the buffer 12 is used as a control signal Gs1 supplied to the gate of the gate transistor G1, and the output signal of the level shifter 13 is used as a control signal Gs2 supplied to the gate of the gate transistor G2.

The output circuit 5-i of FIG. 7 receives control signals IN1 to IN6 from the output control circuit 4. Here, the control signals IN1 to IN3 are signals used for ON-OFF control of the pull-up transistor Gp-i and the pull-down transistor Gn-i, and are generated in response to the display data signal LDi and the recovery control signal CE. On the other hand, the control signals IN4 to IN6 are signals used for ON-OFF control of the gate transistors G1 and G2 of the recovery switch SW-i, and are generated in response to the display data signal LDi.

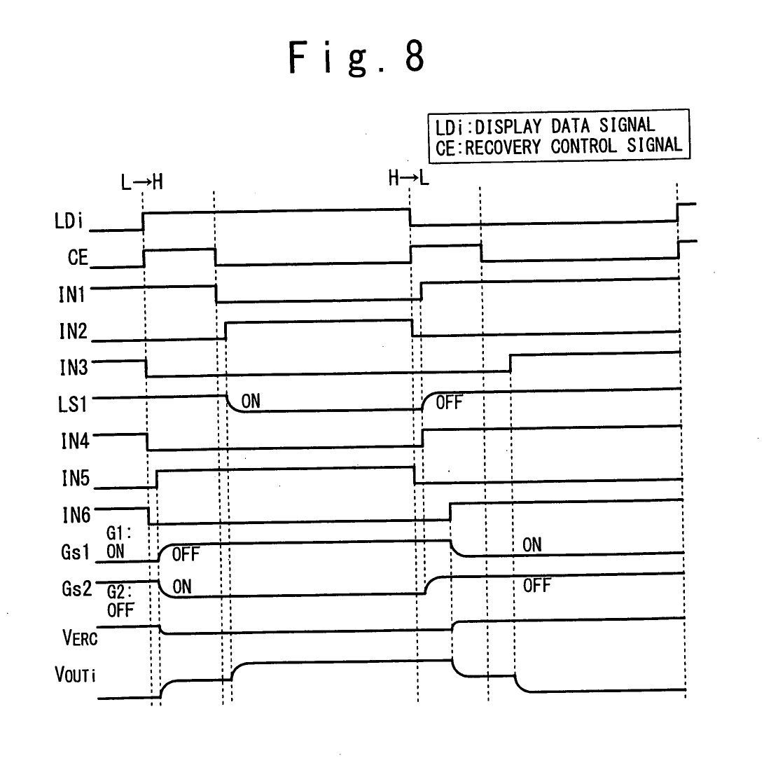

FIG. 8 is a timing chart showing an exemplary operation of the output circuit 5-i of FIG. 7. Initially, the output terminal OUTi is set to the low level. Specifically, in the initial state, the recovery control signal CE is negated, and also the control signal IN1 is set to the high level, the control signal IN2 is set to the low level, and the control signal IN3 is set to the high level. Under such conditions, the output signal LS1 of the level shifter 11 is set to the high level. The pull-up transistor Gp-i is turned off, and the pull-down transistor Gn-i is turned on. In addition, the gate transistor G1 is turned on state and the gate transistor G2 is turned off, in the initial state. Specifically, in the initial state, the control signal IN4 is set to the high level, the control signal IN5 is set to the low level, and the control signal IN6 is set to the high level.

When the output terminal OUTi is pulled up from the low level to the high level, the pull-down transistor Gn-i is first turned off. More specifically, the recovery control signal CE is asserted, and also the control signal IN3 is pulled down to the low level. Consequently, the pull-down transistor Gn-i is turned off.

Subsequently, the gate transistor G1 is turned off, and the gate transistor G2 is turned on. More specifically, the control signals IN4 and IN6 are switched from the high level to the low level, and the control signal IN5 is then pulled up to the high level. Consequently, the recovery switch SW-i is operated to allow a current to flow in the direction from the recovery capacitor connection terminal ERC to the output terminal OUTi, and the charges are supplied from the recovery capacitor C_{ER} to the output terminal OUTi (that is, the data line of the display panel) via the recovery switch SW-i. The lag of the pull-up timing of the control signal IN5 behind the pull-down timing of the control signal IN3 prevents the charges from flowing from the recovery capacitor C_{ER} to the ground terminal via the pull-down transistor Gn-i. At this moment, the voltage VOUTi of the output terminal OUTi, that is, the voltage of the data line is increased to an intermediate voltage level.

The recovery control signal CE is then negated, also the pull-up transistor Gp-i is turned on to pull up the output terminal OUTi to the high level. More specifically, after the negation of the recovery control signal CE, the control signal IN2 is pulled up to the high level. Consequently, the output signal LS1 of the level shifter 11 is pulled down to the low level, and the pull-up transistor Gp-i is turned on.

When the output terminal OUTi is pulled down from the high level to the low level, on the other hand, the pull-up transistor Gp-i is first turned off. More specifically, the recovery control signal CE is asserted, also the control signal IN2 is pulled down to the low level, and subsequently the control signal IN1 is pulled up to the high level. Consequently, the output signal LS1 of the level shifter 11 is pulled up to the high level, and the pull-up transistor Gp-i is turned off.

In addition, the gate transistor G2 is turned off, and the gate transistor G1 is then turned on. The switching of the gate transistor G2 to the OFF state is performed simultaneously with the switching of the pull-up transistor Gp-i to the OFF state. More specifically, the control signal IN5 is pulled down to the low level, and then the control signal IN4 is switched from the low level to the high level. Consequently, the gate transistor G2 is turned off. The control signal IN6 is then pulled up to the high level. Consequently, the gate transistor G1 is turned on. As a result, the recovery switch SW-i is operated to allow a current to flow in the direction from the output terminal OUTi to the recovery capacitor connection terminal ERC, and the charges are recovered from the output terminal OUTi (that is, from the data line of the display panel) to the recovery capacitor C_{ER} via the recovery switch SW-i. The lag of the pull-up timing of the control signal IN6 behind the pull-up timing of the control signal IN1 avoids a current flow from the power supply terminal to the recovery capacitor C_{ER} via the pull-up transistor Gp-i. At this moment, the voltage VOUTi of the output terminal OUTi, that is, the voltage of the data line is decreased to an intermediate level.

The recovery control signal CE is then negated, also the pull-down transistor Gn-i is turned on to pull down the output terminal OUTi to the low level. More specifically, the control signal IN3 is pulled up to the high level after the negation of the recovery control signal CE. Consequently, the pull-down transistor Gn-i is turned on.

It should be noted that, also in the operation of FIG. 8, the switching of the control signals Gs1 and Gs2 needs to be performed only once to switch the output terminal OUTi from the low level to the high level or to switch the output terminal OUTi from the high level to the low level. Such operation effectively reduces frequencies of the control signals Gs1 and Gs2, thereby achieving power consumption reduction (compared to the operation of FIG. 2).

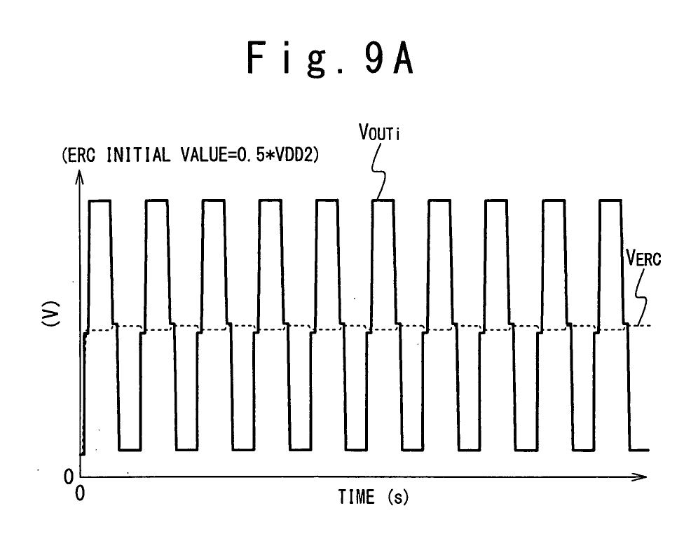

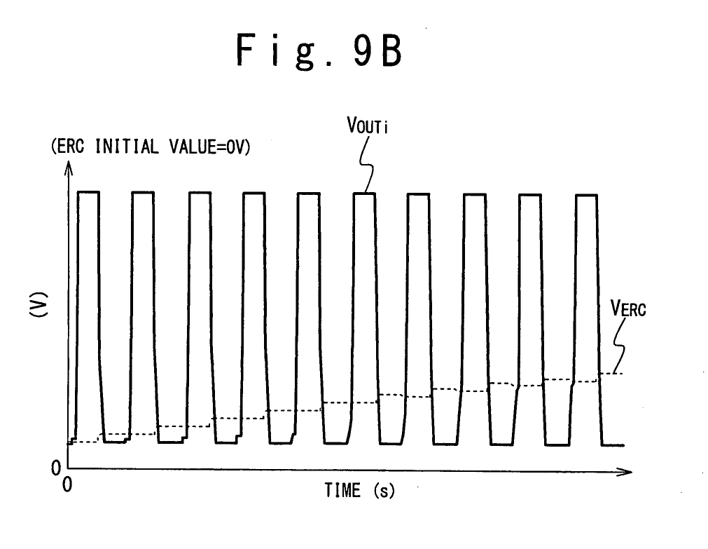

FIGS. 9A and 9B are graphs showing simulation results of the operation of the circuit of FIG. 7. More specifically, FIG. 9A is a graph showing the changes in the voltage V_{ERC} of the recovery capacitor C_{ER} and the voltage V_{OUTi} of the output terminal OUTi in a case where the initial voltage of the recovery capacitor C_{ER} is VDD2/2. On the other hand, FIG. 9B is a graph showing the changes in the voltage V_{ERC} of the recovery capacitor C_{ER} and the voltage V_{OUTi} of the output terminal OUTi in a case where the initial voltage of the recovery capacitor C_{ER} is 0 (that is, in a case where the voltage of the recovery capacitor C_{ER} is 0 upon activation of the display panel driver 1). In either case, it would be understood by those skilled in the art that the charge recovery to the recovery capacitor C_{ER} and the charge supply from the recovery capacitor C_{ER} to the output terminal OUTi (that is, data line) are performed effectively.

It should be noted that, in the operation of FIG. 9B where the voltage of the recovery capacitor C_{ER} is 0 upon the activation of the display panel driver 1, it takes considerable time for the voltage of the recovery capacitor C_{ER} to reach the vicinity of the voltage VDD2/2 after the activation of the display panel driver 1. While the display panel driver 1 has a high charge use efficiency when the voltage of the recovery capacitor C_{ER} is in the vicinity of the VDD2/2, the display panel driver 1 cannot obtain a sufficiently high charge use efficiency until the voltage of the recovery capacitor C_{ER} reaches the vicinity of the VDD2/2.

To avoid such problem, it is preferable that an operation of pre-charging the recovery capacitor C_{ER} be performed after the activation of the display panel driver 1. The display panel driver 1 of this embodiment in the configurations of either FIG. 5 or FIG. 7 can pre-charge the recovery capacitor C_{ER} without requiring any special circuit.

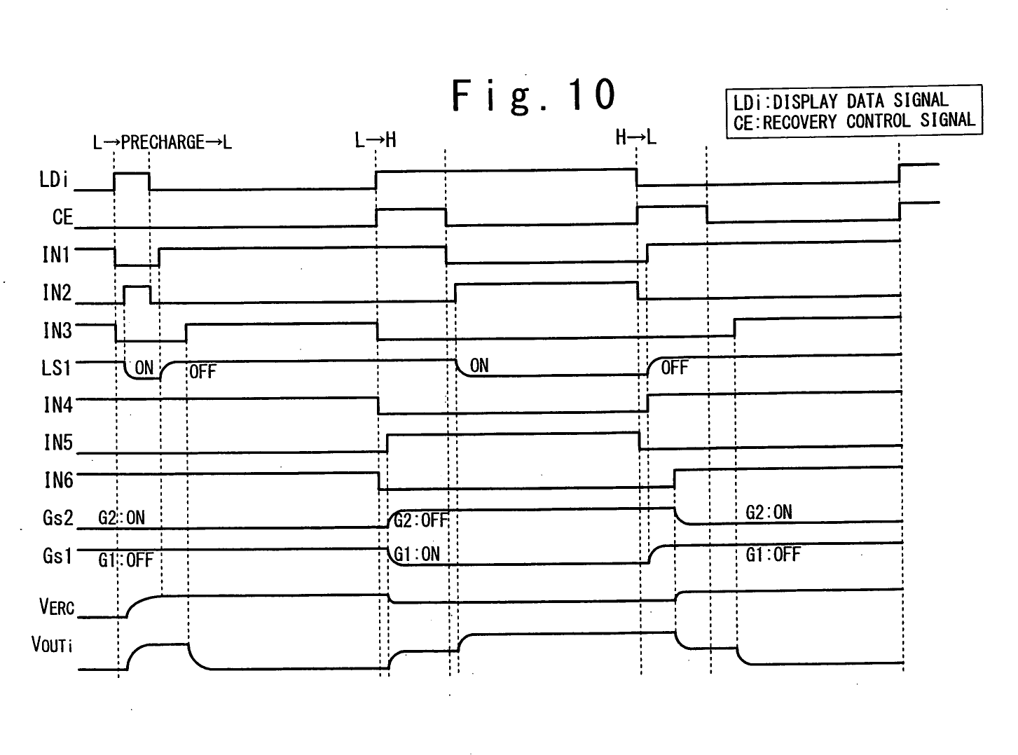

FIG. 10 is a timing chart showing the operation of pre-charging the recovery capacitor C_{ER} in the display panel driver 1 with the configuration of FIG. 7. The pre-charging of the recovery capacitor C_{ER} is performed by setting the recovery switch SW-i such that a current flows in the direction from the output terminal OUTi to the recovery capacitor connection terminal ERC and also keeping the pull-up transistor Gp-i at the ON state for a predetermined period.

In the following, a detailed description is given of the operation of pre-charging the recovery capacitor C_{ER}. In the initial state, the output terminal OUTi is set to the low level. Specifically, the recovery control signal CE is negated, and also the control signal IN1 is set to the high level, the control signal IN2 is set to the low level, and the control signal IN3 is set to the high level. Under such conditions, the output signal LS1 of the level shifter 11 is set to the high level. Consequently, the pull-up transistor Gp-i is turned off, and the pull-down transistor Gn-i is turned on. In addition, the gate transistor G1 is initially turned on and the gate transistor G2 is turned off. Specifically, the control signal IN4 is set to the high level, the control signal IN5 is set to the low level, and the control signal IN6 is set to the high level. Under such conditions, the recovery switch SW-i is operated to allow a current to flow in the direction from the output terminal OUTi to the recovery capacitor connection terminal ERC.

In order to pre-charge the recovery capacitor C_{ER}, the display data signals LD1 to LDn inputted to the output control circuit 4 are first set to the high level. Further, the control signals IN1 and IN3 are pulled down to the low level, and the pull-down transistor Gn-i is turned off. Subsequently, the control signal IN2 is pulled up to the high level, and the output signal LS1 of the level shifter 11 is thereby pulled down to the low level. In response to the pull-down of the output signal LS1, the pull-up transistor Gp-i is turned on, thereby starting the pre-charging of the recovery capacitor C_{ER}. At this moment, the voltage level of the output terminal OUTi is also increased.

Subsequently, after the control signal IN2 is pulled down to the low level, the control signal IN1 is pulled up to the high level. Consequently, the output signal LS1 of the level shifter 11 is pulled up to the high level, and the pull-up transistor Gp-i is turned off. As a result, the pre-charging of the recovery capacitor CER is completed. Subsequently, the control signal IN3 is pulled up to the high level, and the pull-down transistor Gn-i is turned on. Consequently, the output terminal OUTi is pulled down to the low level. Then the operation for pre-charging the recovery capacitor C_{ER} is completed. Thereafter, through the same operation as that of FIG. 8, driving of the output terminal OUTi and the charge recovery and re-use are performed.

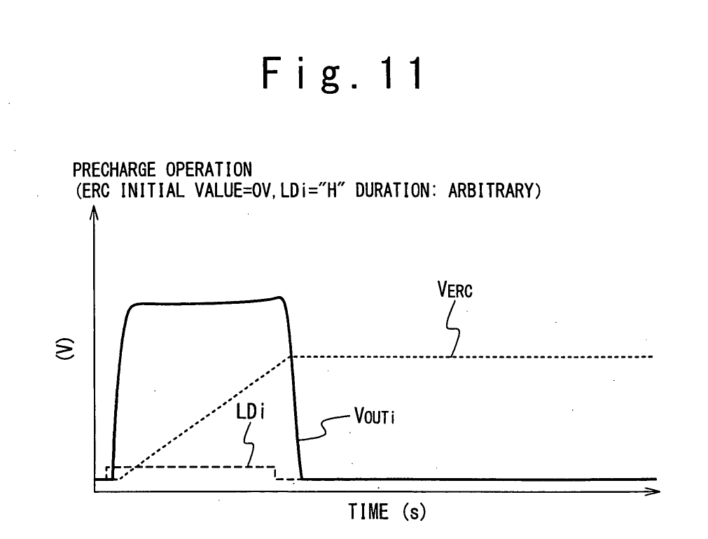

FIG. 11 is a graph showing a simulation result of an operation of pre-charging the recovery capacitor C_{ER} in the circuit configuration of FIG. 7. It would be understood from FIG. 11 that the operation of pre-charging the recovery capacitor C_{ER} is performed effectively.

In summary, the recovery switch SW-i used in the display panel driver 1 of this embodiment has various advantages as follows. First, the area required for integrating the recovery switch SW-i is small. This is based on that the sources of the two gate transistors G1 and G2 within the recovery switch SW-i are commonly connected and floating and thus the MOS transistors in which only the drain has a high withstand voltage can be used as the gate transistors G1 and G2. The use of the MOS transistors in which only the drain has a high withstand voltage is effective in reducing an area of the recovery switch SW-i.

Secondly, the ON resistances of the gate transistors G1 and G2 within the recovery switch SW-i are effectively reduced. This is based on that the back gates of the gate transistors G1 and G2 are directly connected to the sources thereof. Due to the direct connections of the back gates of the gate transistors G1 and G2 to the sources thereof, the ON resistance increase due to the back gate effect does not occur.

Thirdly, the frequencies of the control signals (control signals Gs, Gs1, and Gs2) fed to the gate transistors G1 and G2 are reduced. This is based on that the recovery switch SW-i is so configured as to be capable of controlling the direction of the current flow. The reduction in the frequencies of the control signals contributes to reduction in the power consumption and is also preferable in terms of making it easy to control the operation timings of the pull-up transistor Gp, the pull-down transistor Gn and the recovery switch SW.

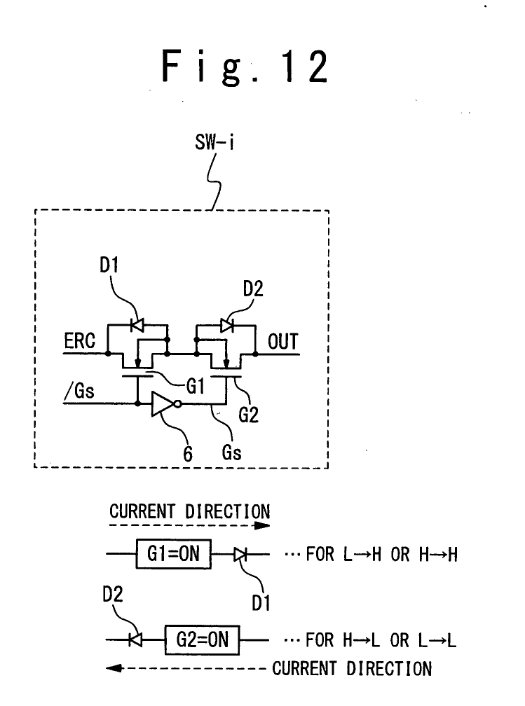

FIG. 12 is a circuit diagram showing an exemplary configuration of a recovery switch SW-i in a second embodiment. With the configuration of FIG. 12, NMOS transistors are used as gate transistors G1 and G2. Even when the circuit configuration of FIG. 12 is adopted, the operation of the recovery switch SW-i is essentially identical to that of the circuit configuration of FIG. 5, except for that the direction of the current flow is inversed due to the difference between the directions of parasitic diodes D1 and D2 and that the signal level of the control signal Gs is inverted. The use of NMOS transistors, which have greater carrier mobility as the recovery switch SW-i (than PMOS transistors), is advantageous in terms of the reduction in the areas of the gate transistors G1 and G2.

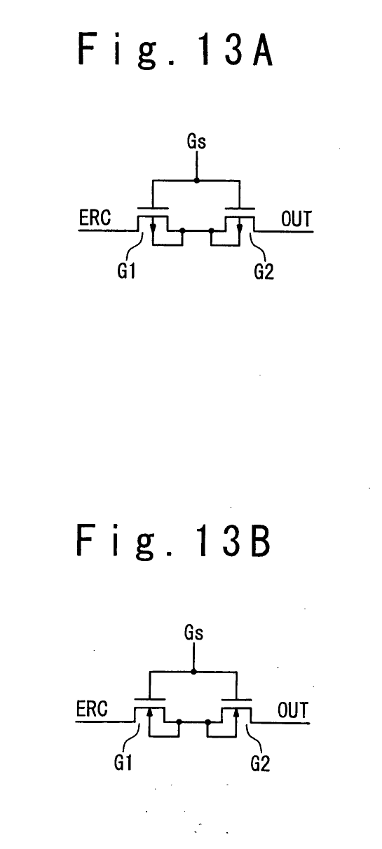

FIGS. 13A and 13B are circuit diagrams showing an exemplary configuration of a recovery switch SW-i in a third embodiment. FIG. 13A shows a configuration in a case where PMOS transistors are used as gate transistors G1 and G2 within the recovery switch SW-i, and FIG. 13B shows a configuration in a case where NMOS transistors are used as the gate transistors G1 and G2.

With the configurations of FIGS. 13A and 13B, the gates of the gate transistors G1 and G2 are both controlled by a common control signal Gs. The gate transistors G1 and G2 need to be kept at the ON state only during charge recovery from the data line to the recovery capacitor C_{ER} and charge supply from the recovery capacitor C_{ER} to the data line. That is, the frequency of the control signal Gs in the third embodiment is increased compared to those of the first and second embodiments. This is disadvantageous in terms of power consumption. However, even the configurations of FIGS. 13A and 13B provide advantages that the area required for integrating the recovery switch SW-i is reduced and that the ON resistances of the gate transistors G1 and G2 including the recovery switch SW-i are reduced. In addition, with the configurations of FIGS. 13A and 13B, the configuration of the drive circuit driving the recovery switch SW-i is simplified, which is advantageous in terms of the element area.

It is apparent that the present invention is not limited to the above embodiments, but may be modified and changed without departing from the scope of the invention.

What is claimed is:

1. A display panel driver comprising:
an output terminal to be connected to a data line of a display panel;
a recovery capacitor connection terminal to be connected to a recovery capacitor; and
a recovery switch connected between said output terminal and said recovery capacitor connection terminal,
wherein said recovery switch includes first and second MOS transistors of the same conductivity type,
a drain of said first MOS transistor is connected to said recovery capacitor connection terminal,
a drain of said second MOS transistor is connected to said output terminal, and
sources of said first and second MOS transistors are connected to each other.

2. The display panel driver according to claim 1, wherein a back gate of said first MOS transistor is connected to the source of said first MOS transistor, and
a back gate of said second MOS transistor is connected to the source of said second MOS transistor.

3. The display panel driver according to claim 1, wherein a withstand voltage of the drains of said first and second MOS transistors is higher than a withstand voltage of the sources of said first and second MOS transistors.

4. The display panel driver, according to claim 1, wherein said recovery switch is placed into a first state in transferring charges from said output terminal to said recovery capacitor connection terminal, said first state being a state in which said recovery switch allows a current to flow only in a direction from said output terminal to said recovery capacitor connection terminal by placing one of said first and second MOS transistors into an ON state and the other of said first and second MOS transistors into an OFF state, and
said recovery switch is placed into a second state in transferring charges from said recovery capacitor connection terminal to said output terminal, said second state being a state in which said recovery switch allows a current to flow only in a direction from said recovery capacitor connection terminal to said output terminal by placing said other of said first and second MOS transistors into an ON state and said one of said first and second MOS transistors into an OFF state.

5. The display panel driver according to claim 4, wherein switchings of said recovery switch from said first state to said second state and from said second state to said first state are performed only when a voltage level of said output terminal is switched between a first voltage level and a second voltage level higher than said first voltage level.

6. The display panel driver according to claim 4, further comprising:
a pull-up transistor for pulling up said output terminal to said second voltage level; and
a pull-down transistor for pulling down said output terminal to said first voltage level,
wherein a pull-up of said output terminal from said first voltage level to said second voltage level is achieved by placing said recovery switch into said second state with both of said pull-up and pull-down transistors turned off, and then turning on said pull-up transistor with said recovery switch kept at said second state, and
a pull-down of said output terminal from said second voltage level to said first voltage level is achieved by placing said recovery switch into said first state with both of said pull-up and pull-down transistors turned off, and then turning on said pull-down transistor with said recovery switch kept at said first state.

7. The display panel driver according to claim 6, wherein pre-charge of said recovery capacitor is achieved by turning on said pull-up transistor for a predetermined period with said recovery switch placed into said first state.

8. A display panel driver, comprising:
an output terminal to be connected to a data line of a display panel;
a recovery capacitor connection terminal to be connected to a recovery capacitor; and
a recovery switch connected between said output terminal and said recovery capacitor connection terminal,
wherein said recovery switch is configured to be settable into first and second states in response to a control signal,
said first state is a state to allow a current to flow only in a direction from said output terminal to said recovery capacitor connection terminal, and
said second state is a state to allow a current to flow only in a direction from said recovery capacitor connection terminal to said output terminal.

9. The display panel driver according to claim 8, wherein said recovery switch includes first and second MOS transistors of the same conductivity type,
a drain of said first MOS transistor is connected to said recovery capacitor connection terminal,
a drain of said second MOS transistor is connected to said output terminal, and
sources of said first and second MOS transistors are connected to each other.

10. A display device, comprising:
A display panel including a data line, and
a display panel driver including:
an output terminal connected to said data line;
a recovery capacitor connection terminal to be connected to a recovery capacitor; and
a recovery switch connected between said output terminal and said recovery capacitor connection terminal,
wherein said recovery switch includes first and second MOS transistors of the same conductivity type,
a drain of said first MOS transistor is connected to said recovery capacitor connection terminal,
a drain of said second MOS transistor is connected to said output terminal, and
sources of said first and second MOS transistors are connected to each other.

11. A display device, comprising:
A display panel including a data line, and
a display panel driver including:
an output terminal connected to said data line;
a recovery capacitor connection terminal to be connected to a recovery capacitor; and
a recovery switch connected between said output terminal and said recovery capacitor connection terminal,
wherein said recovery switch is allowed to be placed into first and second states in response to a control signal,
said first state is a state to allow a current to flow only in a direction from said output terminal to said recovery capacitor connection terminal, and
said second state is a state to allow a current to flow only in a direction from said recovery capacitor connection terminal to said output terminal.

12. A method of operating a display panel driver including an output terminal connected to said data line, a recovery capacitor connection terminal to be connected to a recovery capacitor, and a recovery switch connected between said output terminal and said recovery capacitor connection terminal, said method comprising:
placing said recovery switch into a first state to allow a current to flow only in a direction from said output terminal to said recovery capacitor connection terminal; and
placing said recovery switch into a second state to allow a current to flow only in a direction from said recovery capacitor connection terminal to said output terminal.

13. The method according to claim 12, wherein said recovery switch includes first and second MOS transistors of the same conductivity type,
a drain of said first MOS transistor is connected to said recovery capacitor connection terminal,
a drain of said second MOS transistor is connected to said output terminal, and
sources of said first and second MOS transistors are connected to each other.
